(19) United States
(12) Patent Application Publication
(10) Pub. No.: US 2023/0290142 A1
(43) Pub. Date: Sep. 14, 2023

(54) Apparatus for Augmenting Behavior Data and Method Thereof

(71) Applicants: Hyundai Motor Company, Seoul (KR); Kia Corporation, Seoul (KR)

(72) Inventors: Young Chul Yoon, Seoul (KR); Hyeon Seok Jung, Suwon-si (KR)

(21) Appl. No.: 17/941,339

(22) Filed: Sep. 9, 2022

(30) Foreign Application Priority Data
Mar. 8, 2022 (KR) 10-2022-0029656

(51) Int. Cl. G06V 20/40; G06V 10/22; G06V 10/62; G06V 10/776; G06V 40/20; G06V 10/774

(52) U.S. Cl. CPC G06V 20/41; G06V 10/22; G06V 10/62; G06V 10/776; G06V 40/20; G06V 10/774

(57) ABSTRACT

An embodiment behavior data augmenting apparatus includes a memory storing algorithms and data and a processor configured to execute the algorithms stored in the memory to extract an object region from video data, define a spatiotemporal characteristic for each class of behavior data by a behavior of an object in the object region, augment the behavior data, and perform learning to recognize the behavior of the object based on the augmented behavior data and a learning algorithm.

### CROSS-REFERENCE TO RELATED APPLICATIONS

This application claims the benefit of Korean Patent Application No. 10-2022-0029656, filed on Mar. 8, 2022, which application is hereby incorporated herein by reference.

### TECHNICAL FIELD

The present disclosure relates to a behavior data augmenting apparatus and a method therefor.

### BACKGROUND

Recently, a variety of actions are performed from video data, including event detection, summarization, and visual Q&A, and to this end, techniques for recognizing, analyzing, and classifying various behaviors appearing in video data through a learning algorithm, etc. are being developed.

Conventionally, when a dataset is used and applied to learning, the dataset is classified into at least one class. However, conventionally, correlation between classes is not considered. For example, when class-A and class-B exist, the two classes are determined as completely independent classes, and the correlation between the two classes is not considered at all during learning.

When behavior data augmentation is used, this existing learning method only creates more class-A by augmenting class-A, but there is no case where class-B is augmented to become class-A.

In addition, existing training data is formed to include units of images (videos), so it may not be suitable for object-specific behavior recognition. In addition, since video data has a higher dimensionality than image data, it is difficult to set references for data augmentation.

The above information disclosed in this background section is only for enhancement of understanding of the background of the disclosure, and therefore, it may contain information that does not form the prior art that is already known to a person of ordinary skill in the art.

### SUMMARY

The present disclosure relates to a behavior data augmenting apparatus and a method therefor. Particular embodiments relate to a technique for defining and augmenting behavior data in terms of time and space.

An exemplary embodiment of the present disclosure provides a behavior data augmenting apparatus and a method therefor, capable of spatiotemporally defining and augmenting behavior data for learning during learning by using video data.

The technical objects of embodiments of the present disclosure are not limited to the objects mentioned above, and other technical objects not mentioned can be clearly understood by those skilled in the art from the description of the claims.

An exemplary embodiment of the present disclosure provides a behavior data augmenting apparatus including a processor configured to extract an object region from video data, to define a spatiotemporal characteristic for each class of behavior data by a behavior of an object in the object region, to augment the behavior data, and to perform learning to recognize the behavior of the object based on the augmented behavior data and a learning algorithm and a storage configured to store algorithms and data driven by the processor.

In an exemplary embodiment, the processor may extract an object region for each frame of the video data by using an object detection algorithm.

In an exemplary embodiment, the processor may select one object with highest reliability when at least two objects exist in one frame.

In an exemplary embodiment, the processor may calculate the reliability as a value inversely proportional to a distance between an average position of a trajectory of each object and a center of an image.

In an exemplary embodiment, the processor may define whether temporal directionality exists for each class of the behavior of the object, whether spatial directionality exists, a temporal counterpart when it is played backwards, and a spatial counterpart when it is flipped left and right.

In an exemplary embodiment, the processor may determine that the temporal directionality exists when the behavior of the object is the same only in forward playback of video data.

In an exemplary embodiment, the processor may determine that the spatial directionality exists in the case where the behavior of the object changes even when the video data is flipped left and right.

In an exemplary embodiment, the processor may determine a different class as a temporal counterpart in the case where the temporal directionality exists and the video data is treated as the different class when played backwards.

In an exemplary embodiment, the processor may determine a different class as a spatial counterpart in the case where the spatial directionality exists and the video data is treated as the different class when flipped left and right.

In an exemplary embodiment, the processor may generate a new behavior as new second class data in the case where the new behavior is detected when first class data having the temporal directionality is played backwards.

In an exemplary embodiment, the processor may generate a new behavior as new second class data in the case where the new behavior is detected when first class data having the spatial directionality is flipped left and right.

In an exemplary embodiment, the processor may store and augment first class data having no temporal directionality when a same behavior as that of the first class data is detected in the case where the first class data is played backwards in a learning step.

In an exemplary embodiment, the processor may store and augment first class data having no spatial directionality when a same behavior as that of the first class data is detected in the case where the first class data is flipped left and right in a learning step.

In an exemplary embodiment, the processor may augment same class data by randomly sampling N templates in terms of time in a learning phase.

In an exemplary embodiment, the processor may augment same class data by randomly sampling N templates in terms of space in a learning phase.

In an exemplary embodiment, the processor may define the temporal directionality, the spatial directionality, the temporal counterpart, and other classes not defined by the spatial counterpart as negative classes, and augments the behavior data by using the negative classes when a learning algorithm for object recognition is driven.

In an exemplary embodiment, the processor may recognize the object based on an entire screen of the frame without detecting an object region for each frame of the video data.

An exemplary embodiment of the present disclosure provides a behavior data augmenting method including extracting an object region from video data, defining a spatiotemporal characteristic for each class of behavior data by a behavior of the object, augmenting the behavior data, and performing learning to recognize the behavior of the object based on behavior data and a learning algorithm for each object.

In an exemplary embodiment, the extracting of the object region from the video data may include extracting an object region for each frame of the video data by using an object detection algorithm and selecting one object with highest reliability when at least two objects exist in one frame.

In an exemplary embodiment, the defining of the spatiotemporal characteristic for each class of the behavior data may include defining whether temporal directionality exists for each class of the behavior of the object, whether spatial directionality exists, a temporal counterpart when it is played backwards, and a spatial counterpart when it is flipped left and right.

According to embodiments of the present technique, it is possible to define and augment behavioral data for learning in terms of time and space when learning is performed by using video data.

Specifically, according to embodiments of the present technique, in data augmentation of video data, efficient data augmentation is possible by defining data augmentation reference in four aspects: temporal directionality, spatial directionality, temporal counterpart, and spatial counterpart.

Further, according to embodiments of the present technique, it is possible to augment a number of data in another class by augmenting a number of data in one class.

In addition, according to embodiments of the present technique, it is possible to augment a class by applying a method dependent or non-dependent on a spatiotemporal characteristic for each class that is inputted in advance.

According to embodiments of the present technique, it is possible to improve data augmentation performance by defining and utilizing a negative class.

In addition, various effects that can be directly or indirectly identified through this document may be provided.

### BRIEF DESCRIPTION OF THE DRAWINGS

FIG. 1 illustrates a block diagram showing a configuration of a behavior data augmenting apparatus according to an exemplary embodiment of the present disclosure.

FIG. 2 illustrates an exemplary implementation diagram of a behavior data augmenting apparatus according to an exemplary embodiment of the present disclosure.

FIG. 3 and FIG. 4 illustrate exemplary diagrams showing object detection and post-processing from a dataset for behavior data augmentation according to an exemplary embodiment of the present disclosure.

FIG. 5A to FIG. 5C each illustrate an example of a screen for defining an augmentation reference for a plurality of classes according to an exemplary embodiment of the present disclosure.

FIG. 6A illustrates an example of a screen generating new class data using temporal flipping according to an exemplary embodiment of the present disclosure.

FIG. 6B illustrates an example of a screen generating new class data using spatial flipping according to an exemplary embodiment of the present disclosure.

FIG. 7A illustrates an example of a screen for augmenting a same class through backward playback according to an exemplary embodiment of the present disclosure.

FIG. 7B illustrates an example of a screen for augmenting a same class through left and right flipping according to an exemplary embodiment of the present disclosure.

FIG. 8 illustrates an example of a screen for describing a method for augmenting same class data by a non-dependent temporal augmenting method of temporal characteristics according to an exemplary embodiment of the present disclosure.

FIG. 9 illustrates an example of a screen for describing a method for augmenting same class data by non-dependent spatial augmentation a spatial characteristic according to an exemplary embodiment of the present disclosure.

FIG. 10 illustrates an example of a screen for describing a method of generating negative class data according to an exemplary embodiment of the present disclosure.

FIG. 11 illustrates a flowchart for describing a behavior data augmenting method according to an exemplary embodiment of the present disclosure.

FIG. 12 illustrates a flowchart for describing a process of extracting an object region from video data according to an embodiment of the present disclosure.

FIG. 13 illustrates a flowchart for describing a process of defining a spatiotemporal characteristic for each class according to an exemplary embodiment of the present disclosure.

FIG. 14 illustrates a flowchart for describing a process of augmenting behavior data before learning according to an exemplary embodiment of the present disclosure.

FIG. 15 illustrates a flowchart for describing a process of augmenting behavior data during learning according to an exemplary embodiment of the present disclosure.

FIG. 16A and FIG. 16B each illustrate an example of a screen for describing a spatially augmenting process using one frame according to another exemplary embodiment of the present disclosure.

FIG. 17 illustrates a network structure diagram for dataset learning according to another exemplary embodiment of the present disclosure.

FIG. 18 illustrates a computing system according to an exemplary embodiment of the present disclosure.

### DETAILED DESCRIPTION OF ILLUSTRATIVE EMBODIMENTS

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. In addition, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to exemplary embodiments of the present disclosure, terms such as first, second, A, B, (a), and (b) may be used. These terms are only for distinguishing the constituent elements from other constituent elements, and the nature, sequences, or orders of the constituent elements are not limited by the terms. In addition, all terms used herein including technical scientific terms have the same meanings as those which are generally understood by those skilled in the technical field to which the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

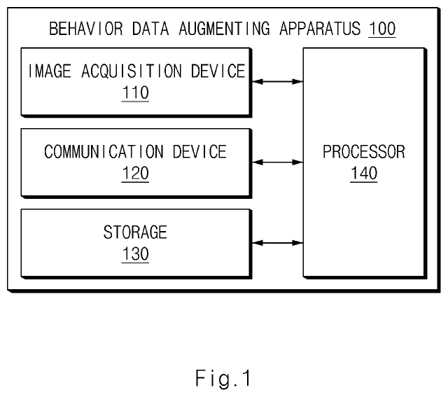

Hereinafter, exemplary embodiments of the present disclosure will be described in detail with reference to FIG. 1 to FIG. 18.

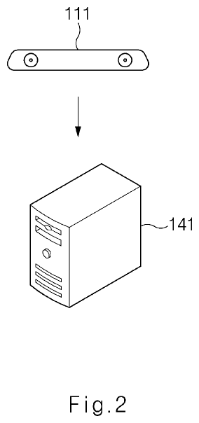

FIG. 1 illustrates a block diagram showing a configuration of a behavior data augmenting apparatus according to an exemplary embodiment of the present disclosure, and FIG. 2 illustrates an exemplary implementation diagram of a behavior data augmenting apparatus according to an exemplary embodiment of the present disclosure.

The behavior data augmenting apparatus 100 according to an exemplary embodiment of the present disclosure may extract an object region from video data to recognize a behavior of an object based on a learning algorithm using behavior data for each object of video data, may define a spatiotemporal characteristic for each class of the behavior data by the behavior of the object, and may augment the behavior data.

The behavior data augmenting apparatus 100 according to an exemplary embodiment of the present disclosure may be implemented inside a vehicle. In this case, the behavior data augmenting apparatus 100 may be integrally formed with internal control units of the vehicle, or may be implemented as a separate device to be connected to control units of the vehicle by a separate connection means.

Referring to FIG. 1, the behavior data augmenting apparatus 100 according to an exemplary embodiment of the present disclosure may include an image acquisition device no, a communication device 120, a memory (i.e., a storage) 13o, and a processor 140.

The image acquisition device no acquires video data for an object. To this end, the image acquisition device no may include a camera.

The communication device 120 is a hardware device implemented with various electronic circuits to transmit and receive signals through a wireless or wired connection, and may transmit and receive information based on in-vehicle devices and in-vehicle network communication techniques. As an example, the in-vehicle network communication techniques may include controller area network (CAN) communication, local interconnect network (LIN) communication, flex-ray communication, and the like. As an example, the communication device 120 may provide data received from the image acquisition device no or the like to the processor 140.

The memory 130 may store image data acquired from the image acquisition device no and data and/or algorithms required for the processor 140 to operate. As an example, the memory 130 may store a learning algorithm such as an object detection algorithm.

The memory 130 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The processor 140 may be electrically connected to the image acquisition device no, the communication device 120, the memory 13o, and the like, may electrically control each component, and may be an electrical circuit that executes software commands, thereby performing various data processing and calculations described below.

The processor 140 may process signals transferred between constituent elements of the behavior data augmenting apparatus 100. That is, the processor 140 may perform general control such that each component may normally perform a function thereof.

The processor 140 may be implemented in the form of hardware, software, or a combination of hardware and software, and may be implemented as a microprocessor, but the present disclosure is not limited thereto. In addition, the processor 140 may be, e.g., an electronic control unit (ECU), a micro controller unit (MCU), or other subcontrollers mounted in the vehicle.

The processor 140 may extract an object region from video data, may define a spatiotemporal characteristic for each class of behavior data by a behavior of an object in the object region, may augment the behavior data, and may perform learning to recognize the behavior of the object based on the augmented behavior data and a learning algorithm.

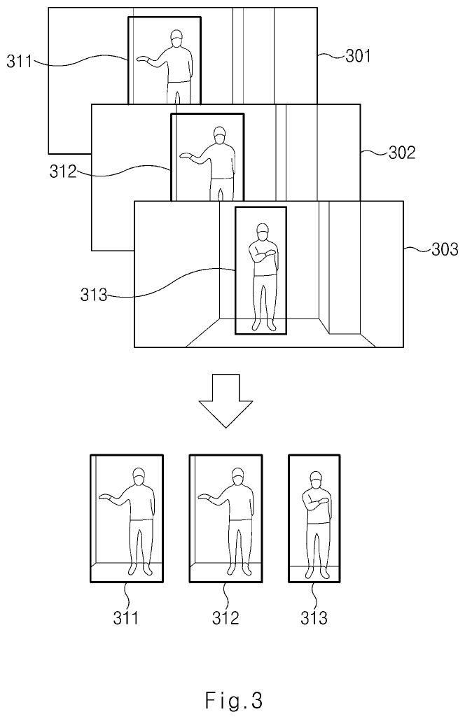

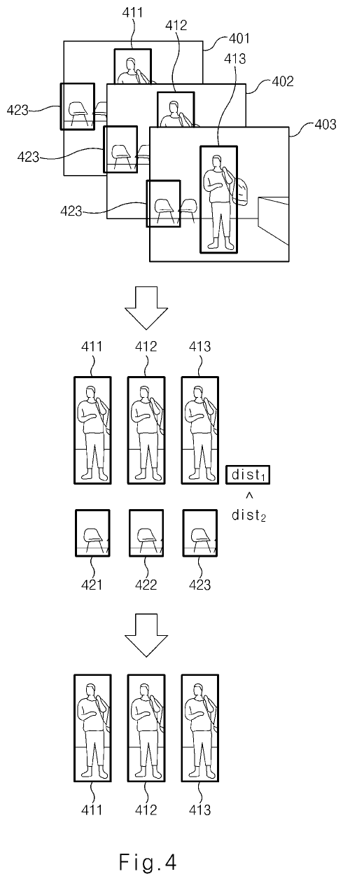

The processor 140 may extract an object region for each frame of video data by using an object detection algorithm, and when at least two objects exist in one frame, may select one object with highest reliability. In this case, the processor 140 may calculate reliability as a value inversely proportional to a distance between an average position of a trajectory of each object and a center of an image. The reliability calculation will be described in detail later with reference to FIG. 3 and FIG. 4.

The processor 140 may define whether temporal directionality exists for each class of the behavior of the object, whether spatial directionality exists, a temporal counterpart when it is played backwards, and a spatial counterpart when it is flipped left and right.

The processor 140 may determine that the temporal directionality exists when the behavior of the object is the same only in forward playback of video data. The processor 140 may determine that spatial directionality exists in the case where the behavior of the object changes even when the video data is flipped left and right.

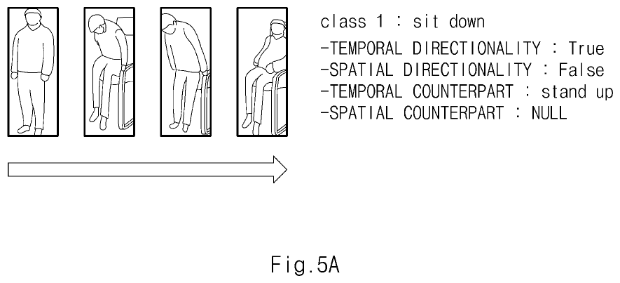

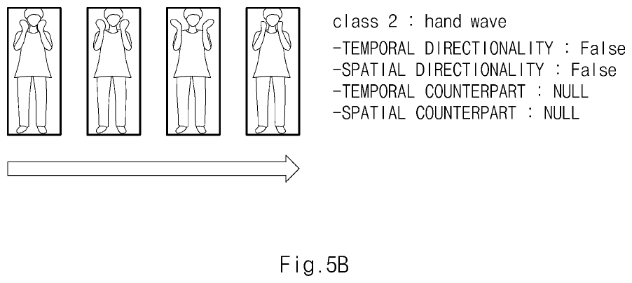

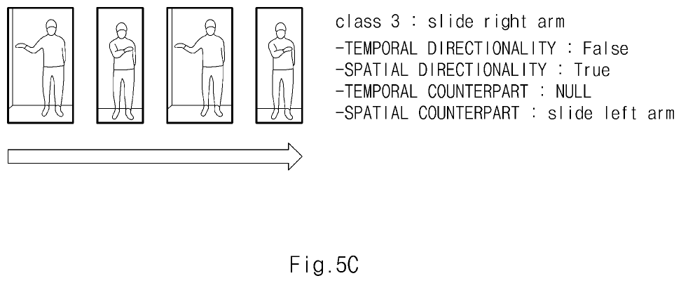

The processor 140 may determine a different class as a temporal counterpart in the case where temporal directionality exists and the video data is treated as the different class when played backwards. In addition, when spatial directionality exists and the video data is treated as the different class when flipped left and right, the processor 140 may determine the different class as a spatial counterpart. The temporal directionality, the spatial directionality, the temporal counterpart, and the spatial counterpart will be described in detail later with reference to FIG. 5A to FIG. 5C.

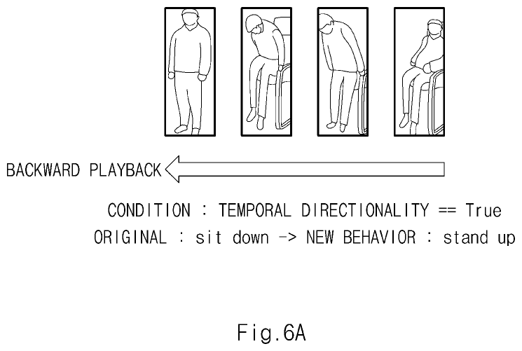

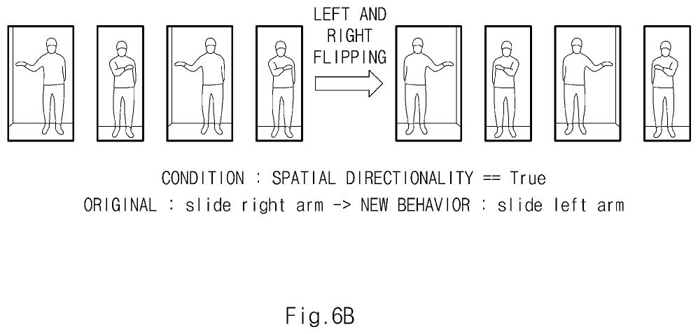

In the case where a new behavior is detected when first class data having the temporal directionality is played backwards, the processor 140 may generate the new behavior as new second class data. This will be described in more detail later with reference to FIG. 6A.

In the case where a new behavior is detected when first class data having the spatial directionality is flipped left and right, the processor 140 may generate the new behavior as new second class data. This will be described in more detail later with reference to FIG. 6B.

In the case where first class data having no temporal directionality is played backwards in a learning step, the processor 140 may store and augment the first class data when a same behavior as that of the first class data is detected.

In addition, when first class data having no spatial directionality is flipped left and right in the learning step, the processor 140 may store and augment the first class data when a same behavior as that of the first class data is detected.

The processor 140 may augment same class data by randomly sampling N templates in terms of time in the learning phase.

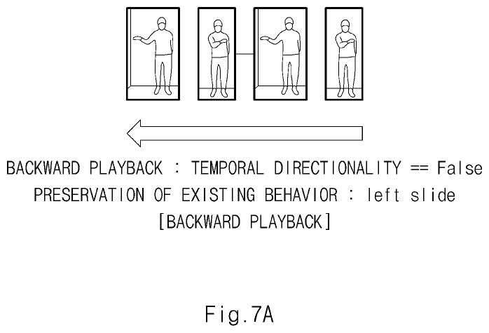

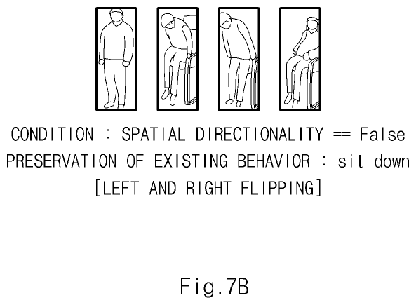

In addition, the processor 140 may augment same class data by randomly sampling N templates in terms of space in the learning phase. An example of augmenting the same class data will be described in more detail later with reference to FIG. 7 to FIG. 9.

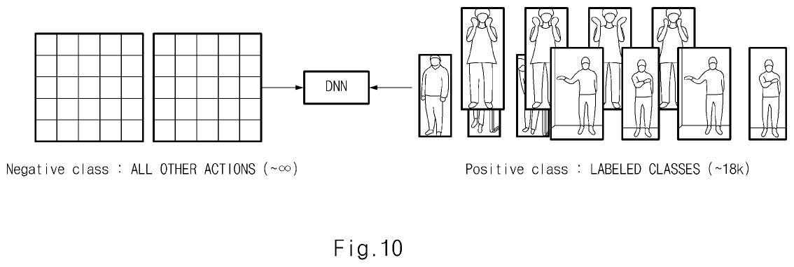

The processor 140 may define temporal directionality, spatial directionality, temporal counterpart, and other classes not defined by the spatial counterpart as negative classes, and may augment the behavior data by using the negative classes when a learning algorithm for object recognition is driven. The negative classes are illustrated later in FIG. 10.

The processor 140 may recognize an object based on an entire screen of a frame without detecting an object region for each frame of video data.

Referring to FIG. 2, the behavior data augmenting apparatus 100 may include a camera 111 corresponding to the image acquisition device 110 of FIG. 1, the communication device 120, the memory 130, and a workstation 141 including a processor 140.

The camera 111 may acquire image data, and the workstation 141 may pre-process a dataset of the image data acquired by the camera in and perform learning.

FIG. 3 and FIG. 4 illustrate exemplary diagrams showing object detection and post-processing from a dataset for behavior data augmentation according to an exemplary embodiment of the present disclosure.

The behavior data augmenting apparatus 100 prepares a collected dataset and a commercial dataset. In this case, the collected dataset and the commercial dataset basically assumes that only one person appears in one video data and performs an action of the corresponding class.

The behavior data augmenting apparatus 100 detects and tracks an object in the collected dataset and the commercial dataset. That is, the behavior data augmenting apparatus 100 may apply an object detection algorithm to extract an object region for each frame, and may apply a multi-object tracking algorithm to match objects between frames.

Referring to FIG. 3, an example of detecting one object 311, 312, and 313 in each of a plurality of frames 301, 302, and 303 is disclosed.

In addition, the behavior data augmenting apparatus 100 may perform post-processing of video image data to generate an accurate dataset. That is, the behavior data augmenting apparatus wo may have two or more objects due to false-positive or a photographing problem. Referring to FIG. 4, an example in which two objects exist in each frame 401, 402, and 403 is disclosed. That is, objects 411 and 421 are detected in the frame 401, objects 412 and 422 are detected in the frame 402, and objects 413 and 423 are detected in the frame 403.

As such, when two or more objects exist in one frame, the behavior data augmenting apparatus 100 may detect one of the two objects.

FIG. 5A to FIG. 5C each illustrate an example of a screen for defining an augmentation reference for a plurality of classes according to an exemplary embodiment of the present disclosure, and FIG. 6A illustrates an example of a screen generating new class data using temporal flipping according to an exemplary embodiment of the present disclosure. FIG. 6B illustrates an example of a screen generating new class data using spatial flipping according to an exemplary embodiment of the present disclosure.

FIG. 5A to FIG. 5C illustrate examples of three classes, but the present disclosure is not limited thereto, and a number and types of classes may vary depending on actions. FIG. 6A and FIG. 6B each illustrate an example of augmenting class-B with class-A.

The behavior data augmentation apparatus 100 may define four items (temporal directionality, spatial directionality, temporal counterpart, and spatial counterpart) for each class in advance. The temporal directionality and the spatial directionality may be defined as Booleans, i.e., true and false, and temporal and spatial counterparts may be defined by class names (numbers).

First, the behavior data augmenting apparatus 100 may define whether the temporal directionality exists. That is, as illustrated in FIG. 5A, since a sit down class is a sit down action only during forward playback, and there is directionality, the temporal directionality may be defined as true. However, as illustrated in FIG. 5B, a hand wave class is a same behavior even when played backwards, and thus therefore, it is defined as false. As illustrated in FIG. 5C, since the temporal directionality does not exist in a slide right arm class, the temporal directionality may be defined as false.

Second, the behavior data augmenting apparatus 100 may define whether the spatial directionality exists. In the case of a slide right arm as illustrated in FIG. 5C, when each image is flipped left and right, it becomes the slide left arm, and thus the spatial directionality is defined as true. Since sit down of FIG. 5A and hand wave of FIG. 5B perform a same action even when they are flipped left and right, the spatial directionality may be defined as false.

Third, the behavior data augmenting apparatus 100 may define the temporal counterpart. That is, in the case of a class with temporal directionality, the temporal counterpart indicates which other class is treated when played backwards. For example, in the case of sit down as illustrated in FIG. 5A, when played backwards (temporally flipped) as illustrated in FIG. 6A, it becomes a stand up class, and thus the counterpart may become a stand up class. The class of FIG. 5B and FIG. 5C has temporal directionality that is defined as false, so the temporal counterpart becomes null.

Fourth, the behavior data augmenting apparatus 100 may define the spatial counterpart. That is, in the case of a class with spatial directionality, the spatial counterpart indicates which other class is treated when flipped left and right. For example, as illustrated in FIG. 5C, when flipped left and right (spatially flipped) as illustrated in FIG. 6B, a slide right arm becomes a slide left arm class, and thus the spatial counterpart becomes the slide left arm. The class of FIG. 5A and FIG. 5B has spatial directionality that is defined as false, so the spatial counterpart becomes null.

As such, the behavior data augmenting apparatus 100 may define spatiotemporal directionality.

In addition, as illustrated in FIG. 6A and FIG. 6B, class-B may be generated using class-A using directionality, and this is differentiated from an existing data augmenting method.

As such, according to embodiments of the present disclosure, it is possible to augment data of other classes or create a class that does not exist by using spatiotemporal directionality, and a class called slide left arm may be automatically created even when only data called slide right arm is photographed. Accordingly, it is possible to greatly reduce a photographing and refinement time of a dataset and increase an amount of the dataset.

Hereinafter, a method of augmenting a same class will be described with reference to using FIG. 7A to FIG. 9. FIG. 7A illustrates an example of a screen for augmenting a same class through backward playback according to an exemplary embodiment of the present disclosure, and FIG. 7B illustrates an example of a screen for augmenting a same class through left and right flipping according to an exemplary embodiment of the present disclosure.

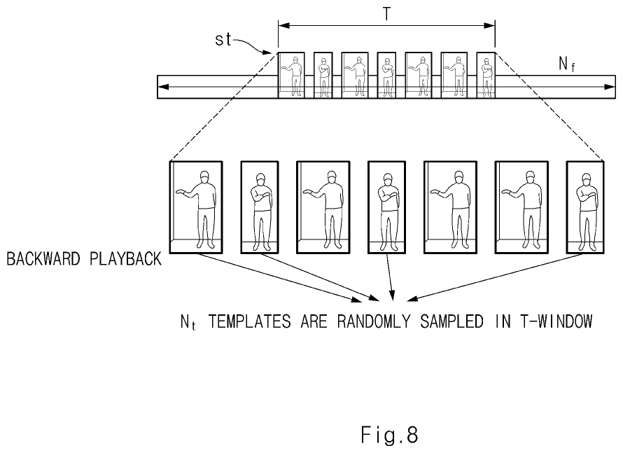

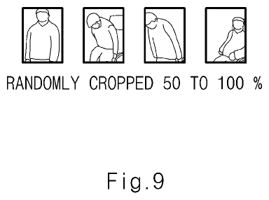

FIG. 8 illustrates an example of a screen for describing a method for augmenting same class data by a non-dependent temporal augmenting method of temporal characteristics according to an exemplary embodiment of the present disclosure. FIG. 9 illustrates an example of a screen for describing a method for augmenting same class data by non-dependent spatial augmentation of a spatial characteristic according to an exemplary embodiment of the present disclosure.

The behavior data augmenting apparatus 100 may augment the same class by utilizing spatiotemporal directionality.

When the temporal directionality is false as illustrated in FIG. 7A, a same action may be performed even when played backwards, and thus the same class may be augmented by playing it backwards. As illustrated in FIG. 7B, when the spatial direction is false, a same class may be augmented by flipping it left and right because it is the same action even when flipped left and right.

As illustrated in FIG. 8, the behavior data augmenting apparatus 100 may apply a spatiotemporal characteristic independent augmenting method. For the spatiotemporal characteristic independent augmenting method, a frame rate may vary each time in the real environment due to augmentation in terms of time, and thus to strengthen it, the behavior data augmenting apparatus 100 may randomly sample N(templates) (16 herein) templates (fᵢ) in a T-size window depending on Equation 1 below during training.

$$templates = \{ {f}_{i} \vert i = rand ( st , st + T ) ∩ {i}_{a} \neq {i}_{b} ( a \neq b ) ∩ N ( templates ) == 16 \} \qquad Equation 1$$

$$st = rand ( 0 , {N}_{f} - T )$$

$$T = max ( 16 , 16 * \frac{F P {S}_{v i d e o}}{F P {S}_{t a r g e t}} )$$

In this case, N_{f} indicates a total length of a video, st indicates a start point of the T-size window. FPS_{target} indicates an actual target FPS, and FPS_{video} indicates a FPS of the dataset.

In addition, as illustrated in FIG. 9, for the behavior data augmenting apparatus 100, as augmentation in terms of space, a person may not be accurately cropped due to noise when an object is detected in a real environment. Accordingly, a person template may be randomly cropped 50 to 100% during learning in order to strengthen it.

height_{new}=rand(height_{org}*0.5,height_{org}) Equation 2

In addition, as illustrated in FIG. 10, data may be augmented by using negative class data. FIG. 10 illustrates an example of a screen for describing a method of generating negative class data according to an exemplary embodiment of the present disclosure.

When the behavior data augmenting apparatus 100 learns only defined classes (e.g., 13), the other classes are not utilized at all for learning.

In order to solve this problem, the behavior data augmenting apparatus 100 may define a negative class, may map all class data other than the class to be used to the negative class, and may use it for learning. When learning in this way, the network can learn a lot of false cases, which can help reduce false-positives in a real environment.

In this case, the negative class can be created by spatiotemporally augmenting the dataset. For example, when sit down is played backwards, it becomes a stand up class, but when a stand up class is not a defined class, it may be mapped to the negative class.

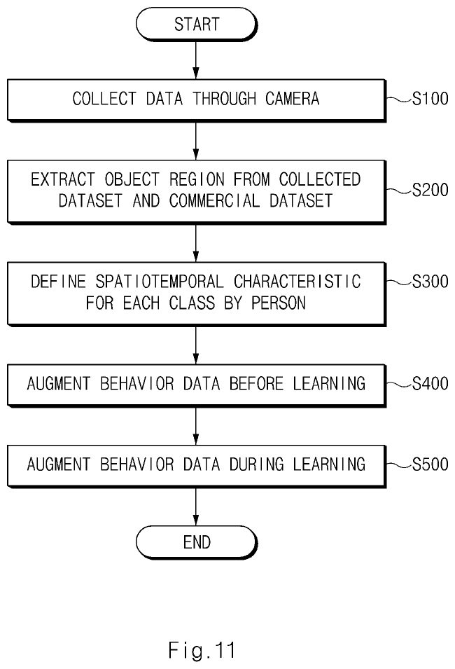

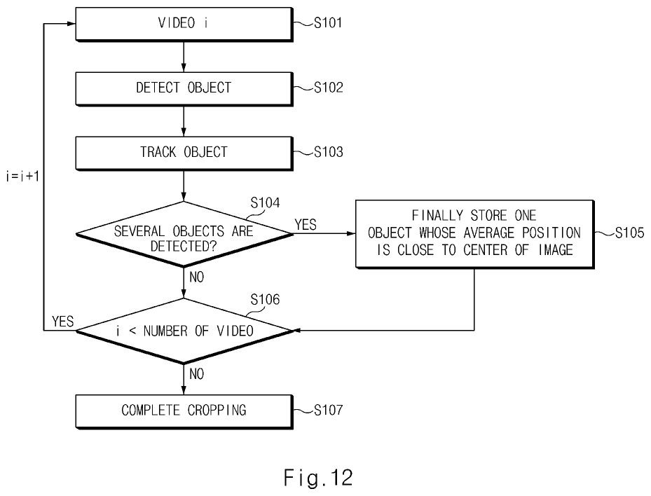

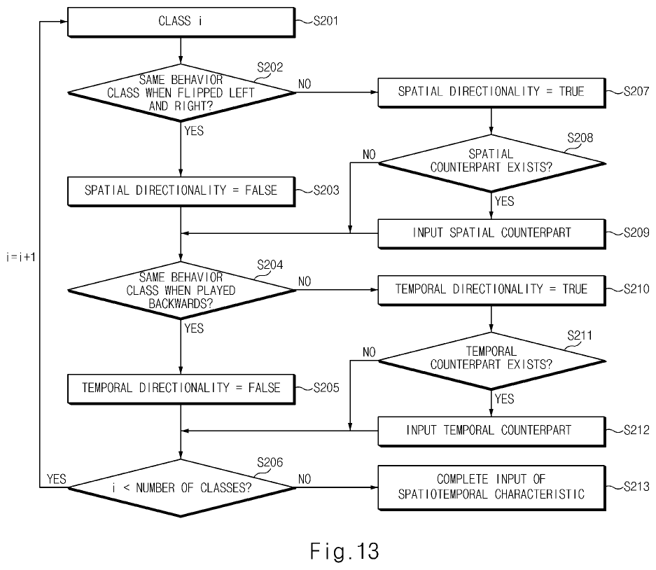

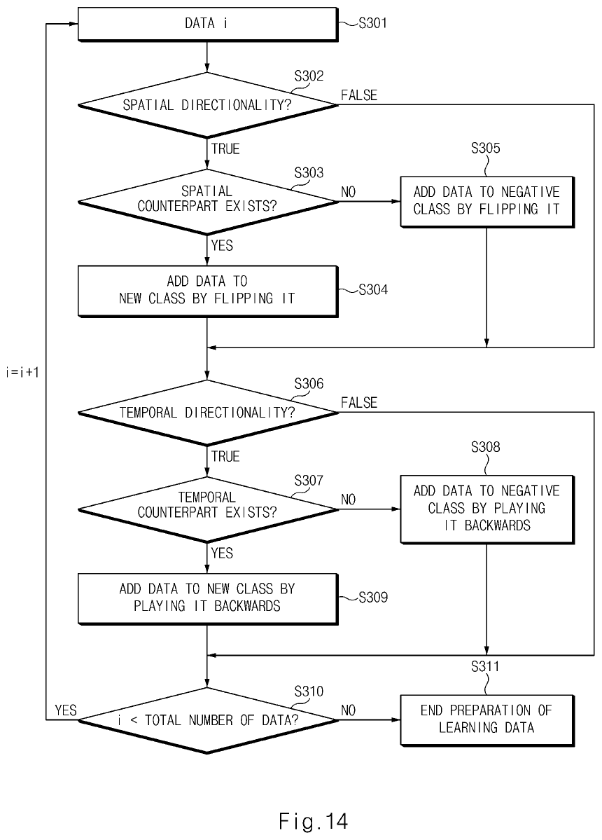

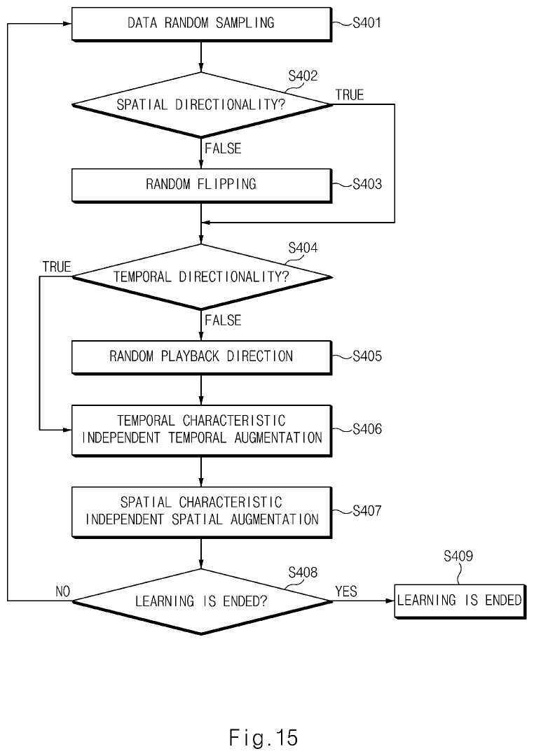

Hereinafter, a behavior data augmenting method according to an exemplary embodiment of the present disclosure will be described in detail with reference to FIG. 11 to FIG. 15. FIG. 11 illustrates a flowchart for describing a behavior data augmenting method according to an exemplary embodiment of the present disclosure, and FIG. 12 illustrates a flowchart for describing a process of extracting an object region from video data according to an embodiment of the present disclosure. FIG. 13 illustrates a flowchart for describing a process of defining a spatiotemporal characteristic for each class according to an exemplary embodiment of the present disclosure, and FIG. 14 illustrates a flowchart for describing a process of augmenting behavior data before learning according to an exemplary embodiment of the present disclosure. FIG. 15 illustrates a flowchart for describing a process of augmenting behavior data during learning according to an exemplary embodiment of the present disclosure.

Hereinafter, it is assumed that the behavior data augmenting apparatus 100 of FIG. 1 performs the processes of FIG. 11 to FIG. 15. In addition, in the description of FIG. 11 to FIG. 15, operations described as being performed by the device may be understood as being controlled by the processor 140 of the behavior data augmenting apparatus 100.

Referring to FIG. 1i, the behavior data augmenting apparatus 100 collects data through a camera (S100).

The behavior data augmenting apparatus 100 extracts an object region from the collected dataset and commercial dataset (S200).

The behavior data augmenting apparatus 100 defines a spatiotemporal characteristic for each class by a person (S300).

The behavior data augmenting apparatus 100 augments behavior data before learning (S400).

The behavior data augmenting apparatus 100 augments behavior data during learning (S500).

Referring to FIG. 12, when receiving video data (video i) (Sim), the behavior data augmenting apparatus 100 detects an object for each frame of the video data (S102).

The behavior data augmenting apparatus 100 tracks the detected object (S103) to determine whether there are several objects detected from one frame (S104).

When there are several detected objects, the behavior data augmenting apparatus 100 finally selects and stores one object whose average position of the object is close to a center of an image (S105).

Thereafter, the behavior data augmenting apparatus 100 determines whether the video data video i in which the object is detected is a last frame (S106). When it is not the last frame, it detects and stores the object by repeating the steps S101 to S105 again, and when it is the last frame, it ends the corresponding process by completing cropping (S107). In this way, the object region is extracted from all video data.

Hereinafter, a process of defining the spatiotemporal characteristic for each class will be described with reference to FIG. 13.

Referring to FIG. 13, in the case of receiving class i (S201), the behavior data augmenting apparatus 100 determines whether class i corresponds to a same behavior class when flipped left and right (S202).

In the case of corresponding to the same behavior class when flipped left and right, it determines whether spatial directionality is false (S203) and whether it corresponds to the same behavior class when played backwards (S204). When the temporal directionality is false (S205), the behavior data augmenting apparatus 100 determines whether i is smaller than a number of classes (S206), and when it is smaller than the number of classes, returns to step 201. The behavior data augmenting apparatus 100 completes input of the spatiotemporal characteristic when i is equal to or greater than the number of classes (S213).

On the other hand, when it is not the same behavior class when flipped left and right in step S202, the behavior data augmenting apparatus 100 determines that the spatial directionality is true (S207) and whether a spatial counterpart exists (S208). When the spatial counterpart exists, after inputting the spatial counterpart (S209), step S204 is entered. In this case, even when the spatial counterpart does not exist, step S204 is entered.

When it is not the same behavior class when played backwards in step S204, the behavior data augmenting apparatus 100 determines that the temporal directionality is true (S210) and whether a temporal counterpart exists (S211). The behavior data augmenting apparatus 100 inputs the temporal counterpart when the temporal counterpart exists (S212). When the temporal counterpart does not exist, or after the temporal counterpart is inputted when it exists, step S206 is entered.

FIG. 14 illustrates a flowchart for describing a process of augmenting behavior data before learning according to an exemplary embodiment of the present disclosure.

Referring to FIG. 14, when receiving data i (S301), the behavior data augmenting apparatus 100 determines spatial directionality of the data i (S302).

When the spatial directionality is true, the behavior data augmenting apparatus 100 determines whether a spatial counterpart exists (S303). When the spatial counterpart exists, the behavior data augmenting apparatus 100 adds data to a new class by flipping it (S304).

Meanwhile, when the spatial counterpart does not exist, the behavior data augmentation apparatus 100 may add the corresponding data to a negative class by flipping it (S305).

Thereafter, the behavior data augmenting apparatus 100 may determine whether the temporal directionality is true or false (S306). In this case, when the spatial directionality is false, the behavior data augmenting apparatus 100 may immediately determine the temporal directionality.

When the temporal directionality is true, the behavior data augmenting apparatus 100 may determine whether a temporal counterpart exists (S307), and when there is the temporal counterpart, may play it backwards to add the corresponding data to a new class (S309).

When the temporal counterpart does not exist, the behavior data augmentation apparatus 100 may play it backwards to add corresponding data to the negative class (S308).

Thereafter, the behavior data augmenting apparatus 100 determines whether i is smaller than a total number of data (S310). When it is smaller, it returns to step S301, and when i is greater than or equal to the total number of data, ends preparation of the learning data (S311).

In this case, when the temporal directionality is false in step S306, the behavior data augmenting apparatus 100 immediately moves to step S310.

FIG. 15 illustrates a flowchart for describing a process of augmenting behavior data during learning according to an exemplary embodiment of the present disclosure.

Referring to FIG. 15, the behavior data augmenting apparatus 100 selects a random sample from among the data (S401) and determines the spatial directionality of the data (S402). When the spatial directionality is false, it performs random flipping (S403).

After determining the temporal direction (S404), the behavior data augmenting apparatus 100 determines a random playback direction when the temporal directionality is false (S405), and performs temporal characteristic independent temporal augmentation (S406).

Then, the behavior data augmenting apparatus 100 performs spatial characteristic independent spatial augmentation (S407), and determines whether learning should be ended (S408). When the learning is to be ended, it ends the learning (S409).

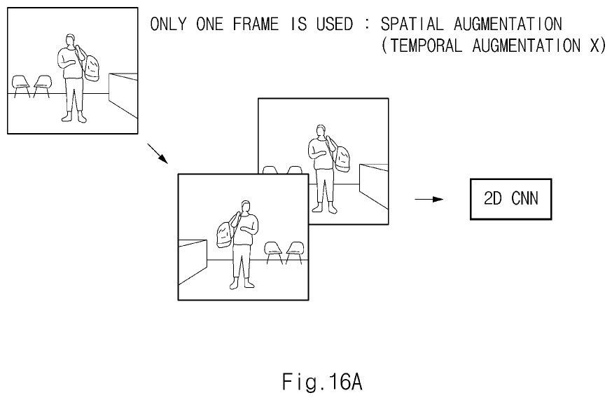

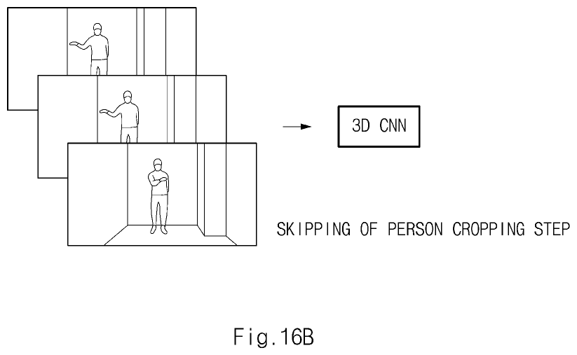

FIG. 16A and FIG. 16B each illustrate an example of a screen for describing a spatially augmenting process using one frame according to another exemplary embodiment of the present disclosure.

FIG. 16A illustrates an example of a screen for describing a spatially augmenting process using one frame according to another exemplary embodiment of the present disclosure. FIG. 16B illustrates an example of a screen in a case in which a human cropping step is omitted from a frame according to another embodiment of the present disclosure.

Referring to FIG. 16A and FIG. 1.6B, it is not specific to a behavior recognition dataset, but is applicable to datasets for various purposes. In addition, behavior data recognition is possible through gesture recognition, sign language recognition, context recognition, pose recognition, and the like. In addition, a format of the dataset may be different. That is, an action may be recognized with only one frame. In this case, only spatial augmentation may be used instead of temporal augmentation. In this case, the action can be recognized based on an entire screen without cropping the person.

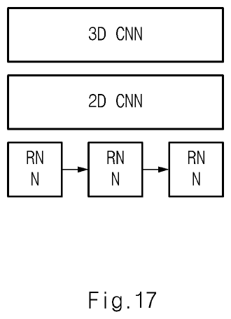

FIG. 17 illustrates a network structure diagram for dataset learning according to another exemplary embodiment of the present disclosure.

Referring to FIG. 17, a network structure that can be learned using the dataset of embodiments of the present disclosure may include a 3D CNN, a 2D CNN, an RNN (LSTM), and a transformer.

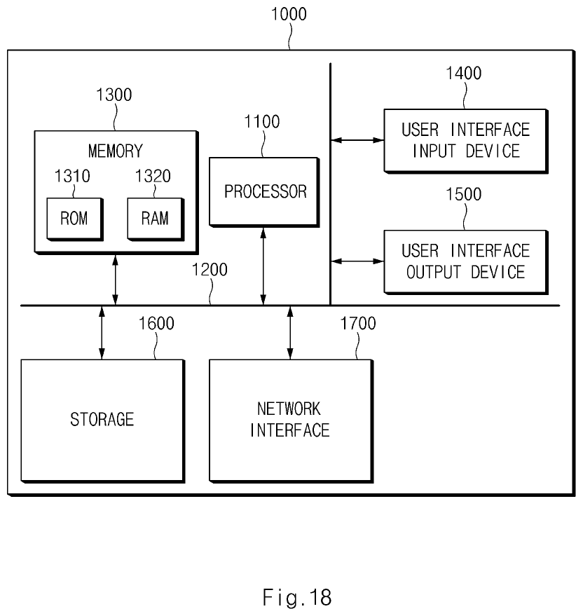

FIG. 18 illustrates a computing system according to an exemplary embodiment of the present disclosure.

Referring to FIG. 18, the computing system 1000 includes at least one processor 1100 connected through a bus 1200, a memory 1300, a user interface input device 1400, a user interface output device 1500, a memory (i.e., a storage) 1600, and a network interface 170.

The processor 1100 may be a central processing unit (CPU) or a semiconductor device that performs processing on commands stored in the memory 1300 and/or the memory 1600. The memory 1300 and the memory 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 1300 and/or the memory 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. A behavior data augmenting apparatus comprising:
a non-transitory memory storing algorithms and data; and
a processor configured to execute the algorithms stored in the memory to:
extract an object region from video data;
define a spatiotemporal characteristic for each class of behavior data by a behavior of an object in the object region;
augment the behavior data; and
perform learning to recognize the behavior of the object based on the augmented behavior data and a learning algorithm.

2. The behavior data augmenting apparatus of claim 1, wherein the processor is configured to execute the algorithms to extract the object region for each frame of the video data by using an object detection algorithm.

3. The behavior data augmenting apparatus of claim 1, wherein the processor is configured to execute the algorithms to recognize the object based on an entire screen of the frame without detecting the object region for each frame of the video data.

4. The behavior data augmenting apparatus of claim 1, wherein the processor is configured to execute the algorithms to select the object having a highest reliability when at least two objects exist in one frame.

5. The behavior data augmenting apparatus of claim 4, wherein the processor is configured to execute the algorithms to calculate reliability as a value inversely proportional to a distance between an average position of a trajectory of each object and a center of an image.

6. A behavior data augmenting apparatus comprising:
a non-transitory memory storing algorithms and data;
a processor configured to execute the algorithms stored in the memory to:
extract an object region from video data;
define a spatiotemporal characteristic for each class of behavior data by a behavior of an object in the object region;
augment the behavior data;
perform learning to recognize the behavior of the object based on the augmented behavior data and a learning algorithm; and
determine whether temporal directionality exists for each class of the behavior of the object, whether spatial directionality exists, a temporal counterpart when the video data is played backwards, and a spatial counterpart when the video data is flipped left and right.

7. The behavior data augmenting apparatus of claim 6, wherein the processor is configured to execute the algorithms to determine that the temporal directionality exists when the behavior of the object is the same only in forward playback of the video data.

8. The behavior data augmenting apparatus of claim 6, wherein the processor is configured to execute the algorithms to determine that the spatial directionality exists when the behavior of the object changes when the video data is flipped left and right.

9. The behavior data augmenting apparatus of claim 6, wherein the processor is configured to execute the algorithms to determine a different class as the temporal counterpart when the temporal directionality exists and the video data is treated as the different class when played backwards.

10. The behavior data augmenting apparatus of claim 6, wherein the processor is configured to execute the algorithms to determine a different class as the spatial counterpart when the spatial directionality exists and the video data is treated as the different class when flipped left and right.

11. The behavior data augmenting apparatus of claim 6, wherein the processor is configured to execute the algorithms to generate a new behavior as new second class data when the new behavior is detected when first class data having the temporal directionality is played backwards.

12. The behavior data augmenting apparatus of claim 6, wherein the processor is configured to execute the algorithms to generate a new behavior as new second class data when the new behavior is detected when first class data having the spatial directionality is flipped left and right.

13. The behavior data augmenting apparatus of claim 6, wherein the processor is configured to execute the algorithms to store and augment first class data having no temporal directionality when a same behavior as that of the first class data is detected when the first class data is played backwards in a learning step.

14. The behavior data augmenting apparatus of claim 6, wherein the processor is configured to execute the algorithms to store and augment first class data having no spatial directionality when a same behavior as that of the first class data is detected when the first class data is flipped left and right in a learning step.

15. The behavior data augmenting apparatus of claim 6, wherein the processor is configured to execute the algorithms to augment same class data by randomly sampling a plurality of templates in terms of time in a learning phase.

16. The behavior data augmenting apparatus of claim 6, wherein the processor is configured to execute the algorithms to augment same class data by randomly sampling a plurality of templates in terms of space in a learning phase.

17. The behavior data augmenting apparatus of claim 6, wherein the processor is configured to execute the algorithms to define the temporal directionality, the spatial directionality, the temporal counterpart, and other classes not defined by the spatial counterpart as negative classes, and to augment the behavior data by using the negative classes when the learning algorithm for object recognition is driven.

18. A behavior data augmenting method comprising:
extracting an object region from video data;
defining a spatiotemporal characteristic for each class of behavior data by a behavior of each object;
augmenting the behavior data; and
performing learning to recognize the behavior of each object based on the behavior data and a learning algorithm for each object.

19. The behavior data augmenting method of claim 18, wherein extracting the object region from the video data comprises:
extracting the object region for each frame of the video data by using an object detection algorithm; and
selecting one object having a highest reliability when at least two objects exist in one frame.

20. The behavior data augmenting method of claim 18, wherein defining the spatiotemporal characteristic for each class of the behavior data comprises determining whether temporal directionality exists for each class of the behavior of each object, whether spatial directionality exists, a temporal counterpart when the video data is played backwards, and a spatial counterpart when the video data is flipped left and right.
